(19) United States
(12) Patent Application Publication
(10) Pub. No.: US 2026/0262569 A1
(43) Pub. Date: Sep. 10, 2026

(54) SPOOL, THREAD MOWING HEAD AND METHOD FOR ASSEMBLING A THREAD MOWING HEAD

(71) Applicant: Andreas Stihl AG & Co. KG, Waiblingen (DE)

(72) Inventors: Sebastian Schmidt, Sinzheim (DE); Sven Leix, Erkenbrechtsweiler (DE)

(73) Assignee: Andreas Stihl AG & Co. KG, Waiblingen (DE)

(21) Appl. No.: 19/542,718

(22) Filed: Feb. 18, 2026

(30) Foreign Application Priority Data
Mar. 5, 2025 (DE) 10 2025 108 233.2

(51) Int. Cl. A01D 34/416

(52) U.S. Cl. CPC A01D 34/4166; A01D 34/4161

(57) ABSTRACT

A spool for a thread mowing head is specified, comprising a supply portion which is designed to accommodate a plurality of windings of a mowing thread of the thread mowing head, a bearing portion which is designed to rotatably mount the spool about a rotational axis of the spool on the thread mowing head, wherein the spool further comprises a tool portion which is designed to actuate a screw connection element for assembling the thread mowing head. Furthermore specified is a thread mowing head with a housing that can be opened without tools and the spool arranged therein, as well as a method for assembling the thread mowing head on a drive shaft for driving the thread mowing head.

### CROSS-REFERENCE TO RELATED APPLICATIONS

This application claims priority of German Patent Application No. 10 2025 108 233.2, filed Mar. 5, 2025. The disclosure of this prior application is considered part of the disclosure of this application and is hereby incorporated by reference in its entirety.

### FIELD

The disclosure relates to a spool for a thread mowing head, a thread mowing head with a spool, and a method for assembling a thread mowing head on a drive shaft.

### BACKGROUND

Thread mowing heads with spools are known from prior art. Several windings of mowing thread are stored on the spool so that a worn mowing thread can be readjusted by a relative movement of the spool and the housing of the thread mowing head. Various readjustment mechanisms are known to those skilled in the art for this purpose. A screw connection element is often used to attach the thread mowing head to the drive shaft. Designs are known in which the screw connection element is integrated in a housing part. To attach the thread mowing head to the drive shaft, the housing part must be rotated relative to the drive shaft. Although the housing has a relatively large circumference, so that no additional tool is required for loosening, the production costs are increased due to the overmolded screw connection element. Furthermore, thread mowing heads are known in which the housing or the spool is fitted onto the drive shaft and then fixed to the drive shaft by screwing on a nut. A tool is required to loosen the nut. It has been shown that the tool is not always carried along, for example because it is forgotten or the operator deliberately does not permanently want to carry the additional weight of the tool.

### SUMMARY

The task is to specify a thread mowing head that is at least partially improved regarding the disadvantages mentioned. This task is solved by the spool for the thread mowing head specified in claim 1 and the thread mowing head specified in claim 8. Furthermore, the task is to specify a method for assembling a thread mowing head on a drive shaft that is improved regarding the disadvantages mentioned. The task is solved by the method specified in claim 10.

Due to the fact, that the spool comprises, in addition to the supply section and the bearing section, a tool section which is designed to actuate a screw connection element, no additional tool must be carried along for actuating, i.e., for loosening or tightening, the screw connection. Due to the fact that the spool comprises the tool section, the tool is always available. The screw connection element is understood to be a nut, screw, or similar threaded element that can be screwed to a corresponding thread on the drive shaft in order to fasten the thread mowing head to the drive shaft.

The tool section refers to the section of the spool contacting the screw connection element when using the spool as a tool and exerts a torque on the screw connection element when rotating the spool. In particular, the tool section is formed rotationally symmetrical to the rotational axis. As a result, no imbalances occur during operation of the thread mowing head due to the tool section and no additional masses are required for balancing the tool section on the spool.

In some examples, the tool section has an elevation with a circumferential contour deviating from the circular shape for actuating the screw connection element. In an alternative embodiment, the tool section has a recess, in particular an opening, with a circumferential contour deviating from the circular shape for actuating the screw connection element. In particular, the circumferential contour is designed as a square, hexagon or other rotationally symmetrical geometry that is matched to a mating contour of the screw connection element.

In some implementations, the spool has a sleeve, and the tool section is formed on the sleeve, in particular on an end face of the sleeve. By utilizing the high weight-specific rigidity of the sleeve, the tool section can be designed to be lightweight yet relatively rigid. A particularly robust arrangement is achieved if the tool section is formed as an opening in the end face of the sleeve. After penetrating the wall thickness of the end face, the screw connection element can plunge into the cavity of the sleeve. This prevents the tool section from unintentionally slipping off the screw connection element. In some aspects, the bearing section of the spool is also arranged on the sleeve, in particular on an inner circumference of the sleeve.

In particular, the sleeve runs coaxially to the rotational axis of the spool. In this way, when used as a tool, the spool is rotated about the same axis about which it also rotates during operation. Thus, the use of the spool as a tool is particularly intuitive for the operator. At the same time, a rotationally symmetrical arrangement of the tool section is particularly easy to realize in this way.

If the supply section, the bearing section, and the tool section are made of the same material, in particular of a plastic material, the spool can be designed and manufactured in a particularly weight-and cost-efficient manner. In particular, existing structures of the spool can additionally be used for new functions. In this way, even more weight can be saved compared to an additional tool. For example, the spool can have a flange that limits the supply section and at the same time forms a handle at which the spool is gripped when used as a tool. In some examples, the spool has a sleeve, on the inner circumference of which the bearing section is arranged and on the end face of which the tool section is arranged. In this way, the tool section benefits from the rigidity of the sleeve shape, which is intended for storing the spool anyway. The addition of the tool section to the spool can be done almost neutral in weight. Almost neutral in weight means a weight increase or weight decrease of no more than 10 percent compared to the same spool without the tool section.

In some implementations, the tool section protrudes beyond the supply section, particularly in the axial direction relative to the rotational axis. This makes the tool section more visible to the operator when using the spool as a tool and thus easier to attach to the screw connection element. In particular, the tool section protrudes beyond any flange that may be present and which axially limits the supply section. If the tool section is formed on a sleeve which, in particular, also supports the bearing section, the sleeve is axially extended in such a way that its axial end protrudes beyond the supply section.

In order to operate the screw connection element with minimal effort, the outer diameter at which the spool is gripped and turned when used as a tool is at least 3 cm, in particular at least 6 cm. To ensure that the diameter can still be easily gripped with one hand, the diameter is in particular no more than 12 cm. In particular, the diameter for gripping the spool is formed on a flange limiting the supply section.

During operation of the thread mowing head on a drive shaft, the spool is arranged in a housing of the thread mowing head and is thus largely protected from contamination. To facilitate removal of the spool from the housing, the housing comprises a first and a second housing part which can be connected to each other and separated without tools. The operator can quickly and easily access the spool as a tool by simply disconnecting the housing parts. In particular, the first housing part and the second housing part are connected by a snap-fit connection. After opening the housing, in particular removing the second housing part, the spool can be removed from the first housing part. In particular, the second housing part secures the spool against falling out of the first housing part.

In some aspects, the thread mowing head comprises a switching device for adjusting the mowing thread from the supply section. Such switching devices are known to those skilled in the art. In some examples, the tool section is arranged within a cavity limited by a spring of the switching device. Such an arrangement allows the tool section to be housed in the thread mowing head in a particularly space-saving manner. In particular, the spring is attached to the second housing part. In this way, the spring is removed together with the second housing part when opening the housing.

The tool section of the spool is only in operative connection with the screw connection element when using the spool as a tool. Torque is only transmitted between the tool section of the spool and the screw connection element when using the spool as a tool. No torque is transmitted between the tool section of the spool and the screw connection element during operation of the thread mowing head.

When using the spool as a tool, the spool must be removed at least partially from the housing of the thread mowing head. For this purpose, the first housing part and the second housing part must be separated from each other. In order to assemble the thread mowing head on a drive shaft for driving the thread mowing head, the first housing part must be placed on the drive shaft and the screw connection element must be threaded onto the drive shaft. Then, the tool section of the spool is placed on the screw connection element and a torque is transmitted to the screw connection element by turning the spool. This tightens the screw connection. Then, the tool section is removed from the screw connection element and the spool is inserted into the first housing part. The second housing part is then connected to the first housing part. The thread mowing head is now ready for use. To remove the thread mowing head from the drive shaft, the second housing part is separated from the first housing part. The spool is removed from the first housing part. Then, the tool section of the spool is placed on the screw connection element and a torque is transmitted to the screw connection element by turning the spool. This loosens the screw connection. The screw connection element is then unscrewed from the drive shaft and the first housing part is removed from the drive shaft. In order to store the thread mowing head, the spool is reinserted into the first housing part and the housing is closed with the second housing part.

When used as a tool and during operation of the thread mowing head, the spool has a different orientation relative to the first housing part. In particular, the different orientation represents an 180° turn of the spool. This means that the spool must be turned to use the tool section and turned again to place the spool in the housing for operation.

### BRIEF DESCRIPTION OF THE DRAWINGS

Further features of the disclosure are apparent from the description and the drawing, in which an example configuration of the disclosure described in detail is illustrated below:

FIG. 1 shows a side view of a thread mowing head assembled on a drive shaft in a longitudinal section along a rotational axis of the thread mowing head,

FIG. 2 shows an isometric view of the spool of the thread mowing head of FIG. 1 without mowing thread loaded in the supply section,

FIG. 3 shows the thread mowing head of FIG. 1 with the second housing part removed and the spool turned without mowing thread during assembling or disassembling the thread mowing head.

### DETAILED DESCRIPTION

FIG. 1 shows a thread mowing head 100 for cutting grass, brush, and the like. The thread mowing head 100 is assembled on a drive shaft 200 by means of a screw connection element 60 and is driven by the drive shaft 200 around a rotational axis 80 during operation of the thread mowing head 100. The thread mowing head 100 has a housing 50 in which a spool 1 with mowing thread 3 wound onto it is arranged. A free end of the mowing thread 3 protrudes from a thread opening 58 in the housing 50 in order to cut grass. During normal operation of the thread mowing head 100, the housing 50 and the spool 1 do not move relative to each other. In order to unwind new mowing thread 3 from the spool 1 in case of a worn mowing thread 3, the thread mowing head 100 has a switching device which temporarily allows relative movement between the housing 50 and spool 1, thereby enabling mowing thread 3 to be unwound from the spool 1.

In the example implementation, the spool 1 is driven indirectly by the drive shaft 200 via a carrier 30 to drive the thread mowing head 100. The housing 50 is driven by the spool 1 via the unactuated switching device. When actuating the switching device, the housing 50 can rotate relative to the spool 1. It is also readily possible for the housing 50 to be driven by the drive shaft 200 in order to drive the thread mowing head 100. In this case, the spool 1 is carried along by the housing 50 via the unactuated switching device, and when the switching device is actuated, the spool 1 can rotate relative to the housing 50.

The housing 50 comprises a first housing part 51 and a second housing part 52, which are connected to each other without tools via a snap-fit connection. When the mowing thread 3 is used up, the spool 1 can be easily removed and new mowing thread 3 can be wound onto the spool 1. New mowing thread 3 can also be wound onto the spool 1 in a manner known to those skilled in the art without disassembling the housing 50. For this purpose, a thread channel 16 is provided in the spool 1. A mowing thread 3 inserted through the thread opening 58 of the housing 50 is guided through the thread channel 16 through the spool 1 and out of the housing 50 through another thread opening 58. Then, the spool 1 is rotated relative to the housing 50, pulling the mowing thread 3 through the thread openings 58 into the housing 50 and winding it onto the spool 1. In the example shown, a grip disc 31 arranged outside the housing 50 is provided for rotating the spool 1 arranged in the housing 50. The grip disc 31 is operatively connected to the spool 1 via the carrier 30. Rotation of the grip disc 31 causes the carrier 30 and thus the spool 1 to rotate. In a design in which the housing 50 is driven by the drive shaft 200 and the spool 1 is driven by the housing 50, the grip disc 31 can also be designed differently and arranged directly on the spool 1.

The switching device comprises a spring 55 and interacting first switching elements 56 and second switching elements 57, which are designed on the housing 50 and the spool 1. The spring 55 preloads the first switching elements 56 and the second switching elements 57 against each other so that they overlap each other in the axial direction with respect to the rotational axis 80 due to the spring 55, thus blocking any relative rotation of the housing 50 and the spool 1. When actuating the switching device, the spool 1 and the housing 50 perform a relative movement in the axial direction with respect to the rotational axis 80 in the illustrated example, so that the first switching elements 56 and second switching elements 57 disengage from each other and relative rotation is enabled. The spring 55 ensures that the spool 1 and the housing 50 return to their axial starting position without actuating the switching device and that the switching elements 56, 57 prevent relative rotation. In the illustrated example, the spring 55 is designed as a spool 1 spring. The spring 55 limits a cavity into which drive shaft 200 protrudes in the example configuration. A screw connection between the drive shaft 200 and the screw connection element 60 is assembled in the cavity of the spring 55. In the example implementation, the screw connection element 60 secures the carrier 30 to the drive shaft 200.

The spool 1 has a supply section 10 for storing several windings of the mowing thread 3. In the illustrated example, the supply section 10 is divided into two thread chambers, each of which is formed between an outer flange 11 and a center flange 12. The thread channel 16 is formed in the center flange 12. In the illustrated example, second switching elements 57 of the switching device are arranged on at least one of the outer flanges 11. A different arrangement of the second switching elements 57 on the spool 1 is also possible. Radially inside the supply section 10, the spool 1 has a bearing section 15. The spool 1 is rotatably mounted with the bearing section 15 about the rotational axis 80. In the example configuration, the bearing section 15 also forms an axial guide for the spool 1 relative to the housing 50.

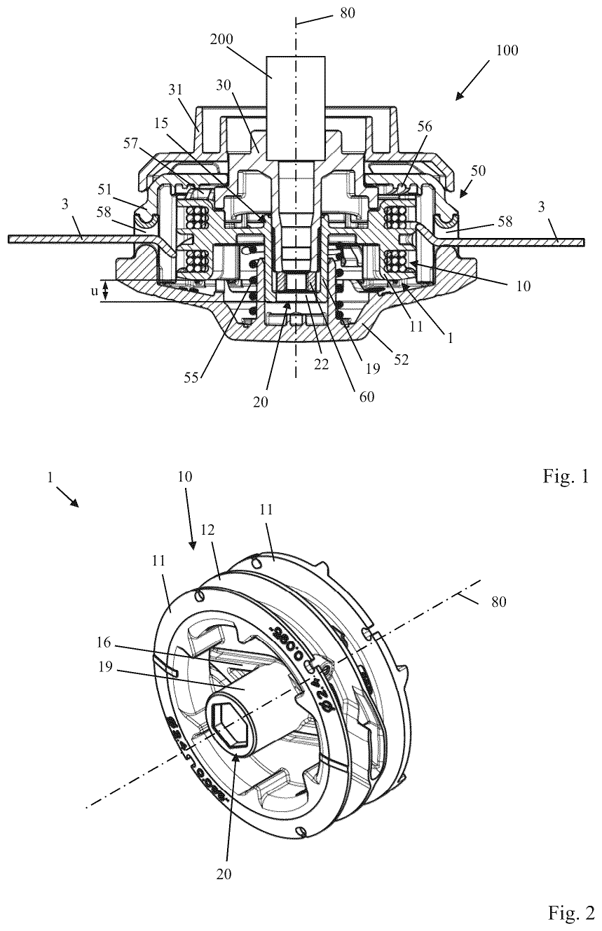

As can be seen in FIG. 2, the spool 1 has a sleeve 19. The sleeve 19 extends along the rotational axis 80. A tool section 20 is formed on one end face of the sleeve 19. The tool section 20 comprises an opening 22 which is formed with a circumferential contour 23 deviating from a circular shape for actuating the screw connection element 60. The circumferential contour 23 is hexagonal in the example implementation. Other designs of the circumferential contour 23 that appear appropriate to those skilled in the art, such as a multi-tooth, are also conceivable. As can be seen in FIG. 1, the bearing section 15 is formed on a circumferential face of the sleeve 19. The spool 1 is mounted on the carrier 30 on an inner circumferential face of the sleeve 19. In the example shown, the spool 1 and the housing 50, in particular the second housing part 52, are mounted on an outer circumferential face of the sleeve 19 so as to be axially displaceable one inside the other. In the illustrated example, the supply section 10, the bearing section 15, and the tool section 20 are formed in one piece. The spool 1 is made of a plastic material, in particular a fiber-reinforced plastic.

During operation of the thread mowing head 100, the tool section 20 protrudes with a protrusion u over the outer flange 12 of the spool 1. During operation of the thread mowing head 100, the screw connection element 60 is arranged inside the sleeve 19, wherein the screw connection element 60 does not protrude into the opening 22 of the tool section 20.

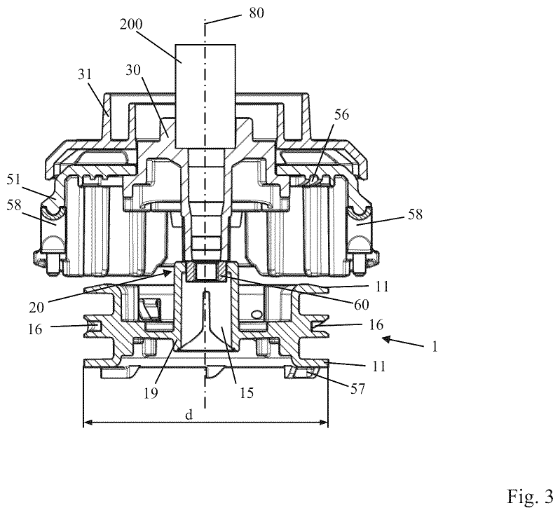

FIG. 3 shows the use of the spool 1 as a tool. The second housing part 52 is separate from the first housing part 51. The spool 1 is removed from the housing 50, turned 180°and placed with the tool section 20 on the screw connection element 60. Due to the protrusion u, the operator can easily recognize the alignment of the tool section 20 to the screw connection element 60 and thus place it more easily. By rotating the spool 1 around the rotational axis 80, a torque can be applied to the screw connection element 60 in order to actuate it. Here, the spool 1 can be gripped by the operator at one or more of the flanges 11, 12 in order to facilitate the application of the torque about the rotational axis 80. The outer diameter d of the flanges is approx. 8 cm. Depending on the size of the thread mowing head 100, the outer diameter d can also be smaller or larger. When using the spool 1 as a tool, the screw connection element 60 plunges into the opening 22. Due to the fact that the tool section 20 is formed on a sleeve 19, the screw connection element 60 can plunge into the cavity of the sleeve 19, which virtually eliminates the possibility of the tool section 20 slipping off the screw connection element 60 when rotating the spool 1. After actuating the screw connection element 60, i.e., loosening or tightening, the spool 1 is removed from the screw connection element 60, turned 180° and reinserted into the first housing part 51. By connecting the second housing part 52 to the first housing part 51, the spool 1 is secured in the housing 50. In the illustrated example, the spring 55 is held on the second housing part 52, so that when connecting the second housing part 52 to the first housing part 51, the spring 55 also automatically brings the first and second switching elements 56, 57 into engagement with one another and thus restoring the operating state of the thread mowing head 100.

What is claimed is:

1. A spool for a thread mowing head comprising:
a supply section which is designed to accommodate a plurality of windings of a mowing thread of the thread mowing head;
a bearing section which is designed to rotatably mount the spool about a rotational axis of the spool on the thread mowing head; and
a tool section which is designed to actuate a screw connection element for assembling the thread mowing head.

2. The spool according to claim 1, characterized in that the tool section is designed to be rotationally symmetrical to the rotational axis of the spool.

3. The spool according to claim 1, characterized in that the tool section has an opening with a circumferential contour deviating from a circular shape for actuating the screw connection element.

4. The spool according to claim 1, characterized in that the spool has a sleeve and the tool section is formed on the sleeve, in particular on an end face of the sleeve.

5. The spool according to claim 1, characterized in that the supply section, the bearing section, and the tool section are made of the same material, in particular of a plastic material.

6. The spool according to claim 1, characterized in that the tool section projects beyond the supply section by a projection u, in particular in an axial direction relative to the rotational axis.

7. The spool according to claim 1, characterized in that the spool has a flange for limiting the supply section, and the flange has an outer diameter which is between 3 cm and 12 cm.

8. A thread mowing head comprising a housing and the spool according to claim 1 arranged therein, wherein the housing comprises a first housing part and a second housing part, which can be connected to each other and separated without tools.

9. The thread mowing head according to claim 8, comprising a switching device for readjusting the mowing thread from the supply section, wherein the switching device comprises a spring and the spring limits a cavity, wherein the tool section is arranged in the cavity.

10. A method for assembling the thread mowing head according to claim 8 to a drive shaft for driving the thread mowing head, comprising the steps of:
a. attaching a first housing part of the housing of the thread mowing head to the drive shaft;
b threading a screw connection element to the drive shaft;
c. placing the tool section of the spool on the screw connection element;
d. tightening the screw connection element by turning the spool;
e. removing the tool section of the spool from the screw connection element;
f. inserting the spool into the first housing part, in particular after previously turning the spool; and
g. connecting a second housing part to the first housing part, in particular by means of a snap-fit connection.
